(19) United States
(12) Patent Application Publication
(10) Pub. No.: US 2025/0191121 A1
(43) Pub. Date: Jun. 12, 2025

(54) ENHANCED FRACTIONAL INTERPOLATION FOR CONVOLUTIONAL PROCESSOR IN AUTONOMOUS OR SEMI-AUTONOMOUS SYSTEMS

(71) Applicant: Tesla, Inc., Austin, TX (US)

(72) Inventors: Gagandeep Sachdev, Austin, TX (US); Peter Sassone, Austin, TX (US); Peter Joseph Bannon, Woodside, CA (US)

(21) Appl. No.: 18/842,753

(22) PCT Filed: Mar. 2, 2023
(86) PCT No.: PCT/US2023/014349

§ 371 Date: Aug. 29, 2024

Related U.S. Application Data
(60) Provisional application No. 63/316,847, filed on Mar. 4, 2022.

(51) Int. Cl. G06T 3/4007; G06T 3/4046

(52) U.S. Cl. CPC G06T 3/4007; G06T 3/4046

(57) ABSTRACT

Systems and methods for enhanced fractional interpolation for a convolutional processor in autonomous or semi-autonomous systems. An example method includes obtaining images from image sensors positioned about a vehicle. For a first image, an interpolation sequence to interpolate the first image according to a fractional interpolation value is determined, with the interpolation sequence including combinations of respective integer interpolations and integer downsamplings. The first image is interpolated according to the interpolation sequence.

### CROSS-REFERENCE TO RELATED APPLICATIONS

This application claims priority to U.S. Patent Prov. App. No. 63/316,847 titled “ENHANCED FRACTIONAL INTERPOLATION FOR CONVOLUTIONAL PROCESSOR IN AUTONOMOUS OR SEMI-AUTONOMOUS SYSTEMS” and filed on Mar. 4, 2022, the disclosure of which is hereby incorporated herein by reference in its entirety.

### BACKGROUND

### Technical Field

The present disclosure relates to a hardware processor, and more particularly, to use of a hardware processor for fractional interpolation.

### Description of Related Art

Interpolation is commonly relied upon to estimate new data points based on known data points. For example, interpolation may be used to adjust the resolution of images which form video presented on a television. In this example, the television may be at a first resolution (e.g., 3,840 pixels by 2,160 pixels) while the video source as at a second resolution (e.g., 1,920 pixels by 1,080 pixels). During presentation of the video source, the television may interpolate the video source to output at the first resolution. As may be appreciated, this interpolation is an integer multiple of the second resolution.

To perform integer interpolation of data (e.g., an image), different techniques may be leveraged. For example, the image may be upsampled by replicating pixels of the image a number of times based on the specific integer. In this example, each pixel may be doubled, quadrupled, and so on. Additionally, integer interpolation may be performed using bilinear interpolation. As known by those skilled in the art, bilinear interpolation is performed using linear interpolation in a first direction and then again in a second direction.

### BRIEF DESCRIPTION OF THE DRAWINGS

FIG. 1A is a block diagram illustrating an example vehicle processor system of a vehicle outputting an image for which fractional interpolation was applied.

FIG. 1B is a block diagram of an input image being interpolated and downsampled according to an interpolation sequence.

FIG. 2A is a flowchart of an example process for performing fractional interpolation using a vehicle processor system.

FIG. 2B is a block diagram illustrating a convolution engine of the example vehicle processor system performing an interpolation sequence according to a fractional interpolation value.

FIG. 3 is a flowchart of an example process for interpolating images received from image sensors included on an autonomous or semi-autonomous vehicle.

FIG. 4 is a block diagram illustrating an example vehicle which includes the vehicle processor system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

This application describes enhanced techniques to perform fractional interpolation of input data, such as images, video sequences, and so on. Fractional interpolation, as may be appreciated with respect to images, allows for fine-grain adjustment of image resolution by allowing for increases which are represented as fractional increases (e.g., 4/3, ⅝, 63/33, and so on). Described herein are details for performing fractional interpolation using efficient computational techniques. These techniques may reduce a time associated with performing fractional interpolation. Additionally, these techniques may allow for a reduction in hardware components required to efficiently perform fractional interpolation. In some embodiments, these techniques may be particularly suited for enhanced fractional interpolation using a convolutional engine or convolutional processing hardware for which interpolation is performed based on convolutional techniques.

As will be described, fractional interpolation may allow for an autonomous or semi-autonomous vehicle to rapidly adjust images in resolution which are received from image sensors positioned on the vehicle. The fractional interpolation may enable complex deep learning models to receive input (e.g., images) of specific sizes regardless of the size of the image sensors positioned on the vehicle. The specific sizes may include all images being a same (e.g., fixed) resolution or certain images being at an increased resolution as compared to other images. For example, images from forward looking image sensors may have increased resolution as compared to images from image sensors positioned at the side of the vehicle. Thus, the forward looking images may be downsampled and/or the side looking images upsampled.

Through the computationally efficient fractional interpolation techniques described herein, hardware elements included on a vehicle may be rapidly adjusted. For example, newer image sensors may be installed in newer versions of a vehicle. In this example, fractional interpolation may be used to adjust output from these newer image sensors in resolution. As another example, newer image sensors may be installed on an existing vehicle in combination with older image sensors. For this example, fractional interpolation may be used to adjust output from these sensors to be a same resolution.

Additionally, the techniques described herein may allow for new versions of machine learning models to be quickly implemented in vehicles through efficient adjustment of resolutions of input images. For example, a newer version of a machine learning model may use input images of larger resolution. In this example, fractional interpolation may be applied to adjust the input images in resolution.

Interpolation allows for input data (e.g., an input image) to be adjusted in the number of elements included in the input data. With respect to the example of the input image, interpolation allows for an increase in the number of pixels included in the input image. Thus, the input image may be adjusted upwards in resolution through use of interpolation. As may be appreciated, this adjustment upwards in resolution causes new data to be estimated for inclusion in the output. While images are described herein, as may be appreciated the input data may be output from a prior layer of a neural network. For example, the input data may be data blobs, tensors, and so on, which are provided to a layer of a neural network (e.g., convolutional neural network) to compute a forward pass through the layer.

Typically, interpolation is performed using integer multiples (‘integer interpolation’). For example, integer interpolation may allow for a doubling, tripling, quadrupling, and so on, of the resolution of an input image. To perform such integer interpolation, different techniques may be leveraged as known by those skilled in the art. For example, nearest neighbor, bilinear, bicubic, spline, and so on. Additionally, interpolation may be performed on an input image using convolution in which a window (e.g., filter or kernel) allows for estimation of new pixels for inclusion in the input image. For example, bilinear interpolation may be performed using convolution in which a kernel is centered on a pixel and nearby pixels are weighted. As may be appreciated, such convolution techniques may, as an example, be referred to as transposed convolution or deconvolution.

Similarly, downsampling may use techniques such as averaging pixel values within a window (e.g., 2×2 pixels). In some embodiments, downsampling may thus leverage convolutional techniques (e.g., pooling, averaging of values in a window, and so on) to downsample. Additional example downsampling techniques include box sampling, mipmap, sinc, use of a stride, and so on.

Advantageously, such convolution-based integer interpolation, and optionally downsampling, may be efficiently implemented in processors which are used to compute forward passes through machine learning models (e.g., neural network models). An example processor which may be used to implement, at least, efficient convolution of input data with windows includes the processor (e.g., matrix processor) described in U.S. Pat. No. 11,157,287, U.S. Patent Pub. 2019/0026250, and U.S. Pat. No. 11,157,441, which are hereby incorporated by reference in their entirety and form part of this disclosure as if set forth herein.

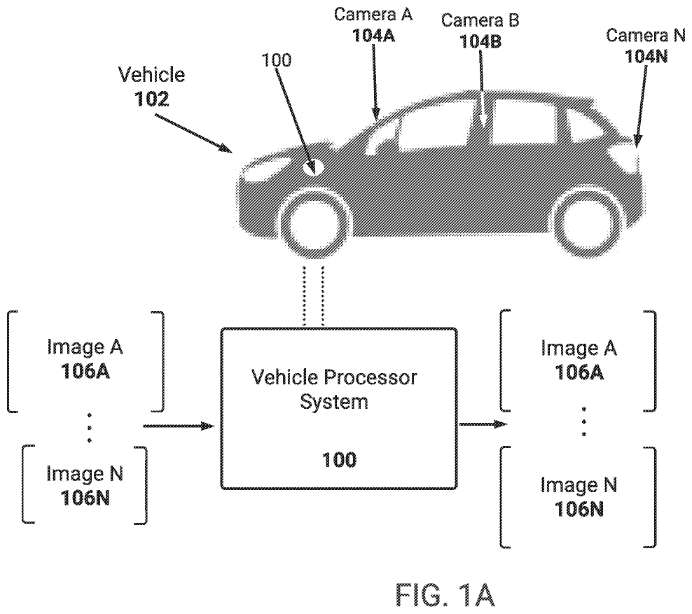

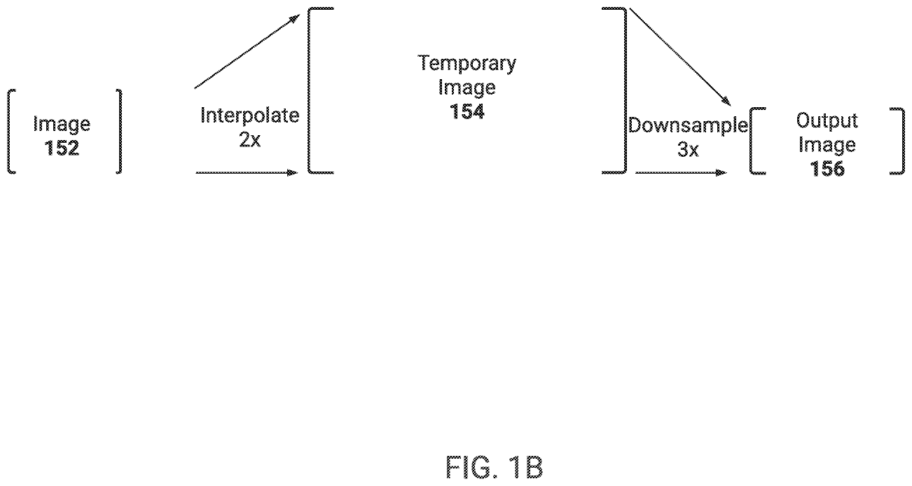

However, such integer interpolation techniques may be too inflexible for more generalized interpolation needs. As described above, an autonomous or semi-autonomous vehicle may use, at least in part, image sensors (e.g., cameras) to obtain input data for use by machine learning models in implementing autonomous or semi-autonomous driving. These image sensors may be positioned about the vehicle, for example as illustrated in FIG. 1A, and thus obtain images for use by the machine learning models. The image sensors may output images of different resolutions, for example due to availability of image sensors or due to a level of detail required for the individual image sensors. Thus, it may be advantageous to adjust images from the image sensors in size (e.g., resolution). As may be appreciated, such adjustment may not be strictly integer-based. For example, a first image sensor may be 4/3 as large as a second image sensor.

Fractional interpolation, as described above, may allow for fractional ratio adjustments. However, implementing such fractional adjustments may typically require complex algorithms or specialized processor hardware elements. With respect to a convolutional engine or processor, such fractional ratios create technological issues as the number of pixels in each window is not fixed and the weights are dependent on the pixel's position in an image. Thus, complex hardware controls may be needed to ensure that fractional interpolation is implemented quickly.

In contrast, the techniques described herein allow for a determination of an interpolation sequence which may be efficiently implemented. In embodiments in which a convolutional engine or processor is used, the interpolation sequence may allow for a computationally efficient performance of fractional interpolation. An interpolation sequence, as described, includes one or more combinations of interpolations (e.g., upsamplings) and downsamplings. For example, an interpolation sequence may include two combinations. In this example, the first combination may cause an interpolation by an integer factor following by a downsampling by an integer factor. As an example, the interpolation may increase the resolution of an image by 3 and then the downsampling will reduce the resolution of the image by 2. In this way, the input image will be effectively fractionally interpolated by 1.5 (e.g., 3/2). A second combination may then follow the first combination. For example, the second combination may interpolate by a factor of 4 and then downsample by a factor of 3). In this example, the output from the first combination will be fractionally interpolated by 5/3. Thus, the input image to the interpolation sequence will be fractionally interpolated by 15/6.

The above-described fractional interpolation allows for efficient use of processors through successive interpolation and downsampling rounds. The techniques described herein may provide immense technological savings with respect to graphical processing units (GPUs), neural processing units (NPUs), processors which implement convolutional engines, hardware application specific integrated circuits (ASICs)) or field programmable gate arrays (FPGAs), and so on.

### Block Diagram

FIG. 1A is a block diagram illustrating an example vehicle processor system 100 of a vehicle 102 outputting an image (e.g., image N) for which fractional interpolation was applied. As illustrated the vehicle includes a multitude of image sensors (e.g., cameras 104A-104N) positioned about the vehicle 102. The cameras 104A-104N may provide a substantially 360-degree view about the vehicle 102 such that autonomous or semi-autonomous driving may be performed. The vehicle 102 may represent a consumer vehicle, such as an electric vehicle, or may represent a commercial vehicle (e.g., a truck, van, and so on). The vehicle 102 may additionally represent an unmanned vehicle, such as an unmanned aerial vehicle, unmanned ground vehicle, and so on). In some embodiments, the functionality described herein may be implemented by a robot which includes one or more cameras.

The vehicle includes a vehicle processor system 100 of one or more processors which implements machine learning models to autonomous or semi-autonomously drive the vehicle 102. For example, the machine learning models may include convolutional neural networks, fully-connected neural networks, and so on. As part of a process to implement autonomous or semi-autonomous driving, the vehicle processor system 100 obtains images from the cameras 104A-104N.

As may be appreciated, the obtained images may need to be adjusted in size (e.g., resolution) to be used by the vehicle processor system 100 to implement autonomous or semi-autonomous driving. For example, the cameras 104A-104N which output images at different resolutions. As an example, camera 104A may output an image at a first resolution while camera 104N may output an image at a second, lesser, resolution. As another example, the machine learning models implemented by the vehicle processor system 100 may use input information at a particular resolution. For example, a machine learning model may use a vectorized image as input to an initial layer or portion of the model or a middle layer or subsequent portion of the model. In this example, the size of the vector may be fixed. Thus, an image may need to be fractionally interpolated to arrive at the size of the vector.

Example images are illustrated as being provided to the vehicle processor system 100 from image sensors (e.g., via a bus or other communication technique). Specifically, image 106A, which is from camera 104A, and image 106N, which is from camera 104N, are illustrated as being received by the vehicle processor system 100. In the illustrated embodiment, the vehicle processor system 100 fractionally interpolates image 106A to correspond to the resolution of image 106A. Thus, image 106A and 106N may be used as the same sized input to a machine learning model (e.g., the same number of elements or pixels).

As will be described in more detail below, the vehicle processor system 100 may fractionally interpolate image 106N by a particular fractional value using an interpolation sequence. For example, the interpolation sequence may include one or more combinations of respective interpolation and downsampling. In this example, the number of combinations may be based on the fractional value which is to be applied to image 106N. For example, if the fractional value may be achieved through one combination, then the vehicle processor system 100 may perform one combination of interpolation and downsampling. An example fractional value may include 4/3 such that the vehicle processor system 100 interpolates image N 106N by 4 (e.g., upsamples by 4) and downsamples by 3.

In some embodiments, the vehicle processor system 100 may limit an extent to which interpolation and downsampling may be applied to image 106N in a single combination. For example, the vehicle processor system 100 may apply interpolations up to a first threshold integer number (e.g., 4, 8, 12, 32, 64, 128) and apply downsampling up to a second threshold integer number (e.g., 4, 8, 12, 32, 48, 64, and so on). Thus, for certain fractional values the vehicle processor system 100 may apply two or combinations of interpolations and downsamplings.

As an example of two or more combinations, a fractional value may be 35/16. For this fractional value, the vehicle processor system 100 may determine to use two combinations with the first representing causing interpolation by the value 7/4 and the second causing interpolation by the value 5/4. This determination may be made based on the number ‘35’ being greater than a threshold number at which the vehicle processor system 100 is configured to interpolate.

For certain fractional values, the vehicle processor system 100 may determine to use a threshold number of combinations to arrive at substantially close values to the fractional values. In some embodiments, the threshold number may be two combinations. As may be appreciated, using two combinations may allow for a substantial number of fractional values to be achieved. In some embodiments, the vehicle processor system 100 applies interpolations up to a first threshold number and downsamples up to a second threshold number. Thus, there may be fractional values which cannot be exactly achieved through two combinations. In these embodiments, the vehicle processor system 100 may determine the closest value to a desired fractional value. In some embodiments, the threshold number of combinations may be 3, 5, 7, 9. In some embodiments, there may be no threshold number of combinations.

To ensure accuracy of the interpolation sequence, the vehicle processor system 100 may start with an interpolation to increase the resolution of image 106N. This interpolation may then be followed by downsampling. In some embodiments, the interpolation sequence may initially include two or more interpolations. In some embodiments, there may be two or more downsamplings followed from an interpolation.

While FIG. 1A illustrates interpolating image 106 to increase the resolution, as may be appreciated the techniques described herein may enable reductions in resolution. For example, FIG. 1B describes an example of fractional interpolation to reduce resolution of an image.

FIG. 1B is a block diagram of an input image 156 being interpolated and downsampled according to an interpolation sequence. The interpolation sequence, as illustrated, causes the input image 152 to be fractionally interpolated by a factor of ⅔. Thus, the resolution of the input image 152 is reduced in this example.

The vehicle processor system 100 may determine the interpolation sequence based on the fractional value of ⅔. Since this fractional value can be achieved with one combination of interpolation and downsampling, the system 100 identifies that the image 152 is to be interpolated by 2 and subsequently downsampled by 3.

In some embodiments, the vehicle processor system 100 may use convolutional techniques to perform the integer interpolation. In this example, a window may be moved across pixels of the image 152 and weights may be applied to pixels proximate to a center pixel of the window. These weights may then be used to estimate new pixels for inclusion in the image 152. In some embodiments, the image 152 may be interpolated according to other techniques. A convolutional engine or processor may be used to perform this integer interpolation as described herein. As described above, the engine or processor may include a matrix processor (e.g., a non-systolic array) which computes a product of weights and input data (e.g., the weights may be arranged on one axis of the matrix and the input data on the other). In some embodiments, a maximum interpolation value may be based on a size associated with the matrix.

Temporary image 154 is illustrated as resulting from the 2× interpolation. This image may be, for example, stored by a convolutional engine or processor (e.g., in cache, temporary storage, and so on). The vehicle processor 100 may then downsample the temporary image 154 by 3. For example, the temporary image 154 may be used as input data to the convolutional engine or processor. Similar to the above, in some embodiments convolutional techniques may be used to perform downsampling. For example, a window may be moved across pixels of the image 154 and pixels within the window averaged, or otherwise combined, to reduce the number of pixels. The resulting output 156 is illustrated in FIG. 1B and represents a fractional interpolation of ⅔.

### Flowcharts

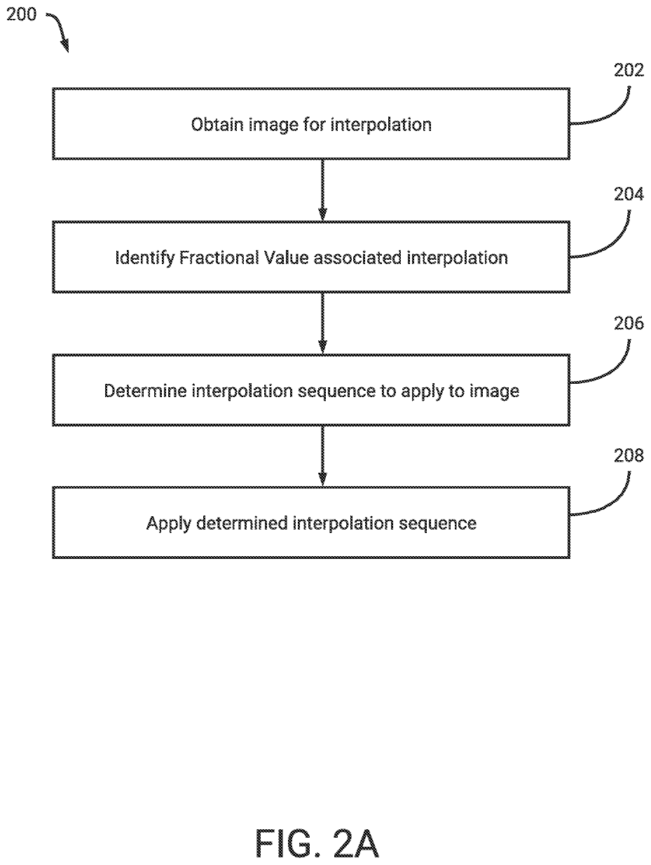

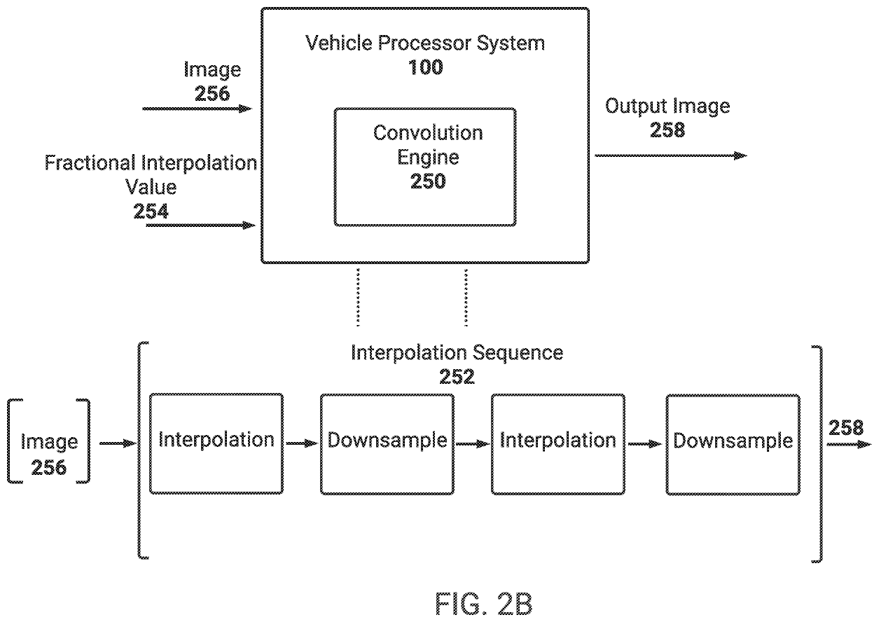

FIG. 2A is a flowchart of an example process 200 for performing fractional interpolation using a vehicle processor system. For convenience, the process 200 will be described as being performed by a system of one or more processors (e.g., the vehicle processor system 100). In some embodiments, the system may be included in a vehicle (e.g., vehicle 102, 400). In some embodiments, the system may represent a portion of a processor (e.g., a convolutional engine or convolutional processor).

At block 202, the system obtains an image for interpolation. As described above, the system may be in communication (e.g., wired or wireless communication) with a camera used to obtain images for processing by the system. For example, the system may be used to implement autonomous or semi-autonomous driving of a vehicle.

At block 204, the system identifies a fractional value associated with interpolation of the image. The system may obtain information indicating a fractional value which is to be applied. For example, the system may implement a pipeline of pre-processing images which are received from cameras. In this example, the system may access information indicating the fractional value. For example, the system may execute code which causes interpolation of the image according to the fractional value.

At block 206, the system determines an interpolation sequence based on the fractional value. As described above, the interpolation sequence may include one or more combinations of interpolations and downsamplings. Thus, the interpolation sequence may include a first combination which includes a first interpolation followed by a second downsampling. The interpolation sequence may also include a second combination which includes a second interpolation followed by a second downsampling. In some embodiments, the system may limit the number of combinations to two.

To determine the interpolation sequence, the system may access information indicating respective integer thresholds for interpolation and downsampling. Thus, the system may limit the highest integer interpolation to 8, 16, 32, 64, 80 times. The system may also limit a highest downsampling to 8, 16, 32, 64, 80 times. These limits may be based on hardware constraints of the system, such as hardware constrains of a convolutional engine or processor. The limits may also be defined in software or code which the system is executing.

With respect to the integer thresholds, the system may therefore determine whether a single combination may effectuate the fractional value. For example, if the fractional value is 8/5, then the system may include a single combination in the interpolation sequence. This single combination would include interpolating the image by 8 and then downsampling the image by 5.

For fractional values which require two, or more, combinations, the system may determine respective interpolation and downsampling values for these combinations. For example, and with respect to two combinations, the system may separate the fractional value into two fractions which, when multiplied, equal the fractional value. In some embodiments, the system may determine the factors of the numerator and denominator. These factors may then be used to select values of the respective interpolations and downsamplings. As described above, certain fractional values may not be precisely achieved, and the system may select values which cause a substantially closest interpolation to be applied.

At block 208, the system applies the determined interpolation sequence. As described above, the system interpolates according to the fractional value using the interpolation sequence.

FIG. 2B is a block diagram illustrating a convolution engine 250 of the example vehicle processor system 100 performing an interpolation sequence 252 according to a fractional interpolation value 254.

In the illustrated embodiment, the convolutional engine 250 receives an image 256 and interpolates the image according to the fractional interpolation value 254. The vehicle processor system 100, or convolution engine 250, can determine the interpolation sequence 252 which causes interpolation by the fractional interpolation value 254. As illustrated in FIG. 2B, the interpolation sequence 252 includes two combinations of interpolations and downsamplings.

As described above, the convolution engine 250 can implement interpolation using convolutional techniques. Additionally, the convolution engine 250 can implement downsampling using convolutional techniques. Thus, the image 256 may be interpolated by the engine 250, and the output provided back to the convolution engine 250 for subsequent downsampling according to the interpolation sequence 252.

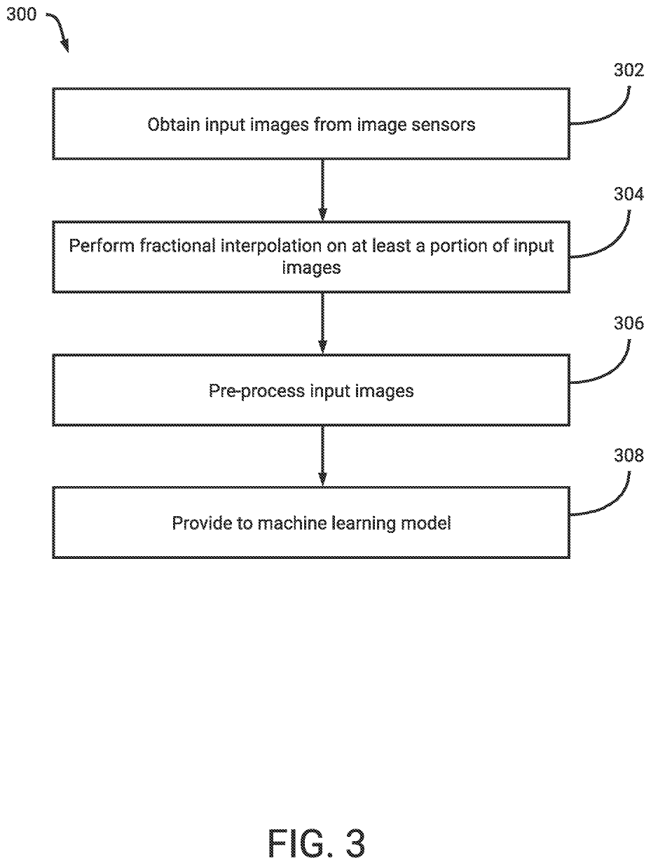

FIG. 3 is a flowchart of an example process 300 for interpolating images received from image sensors included on an autonomous or semi-autonomous vehicle. For convenience, the process 300 will be described as being performed by a system of one or more processors (e.g., the vehicle processor system 100). In some embodiments, the system may be included in a vehicle (e.g., vehicle 102, 400). In some embodiments, the system may represent a portion of a processor (e.g., a convolutional engine or convolutional processor).

At block 302, the system obtains input images from image sensors. As illustrated in FIG. 1A, the system may obtain images from cameras positioned about a vehicle.

At block 304, the system performs fractional interpolation on at least a portion of the input images. The system identifies whether images from each camera are to be fractionally interpolated. For example, the cameras may operate at different resolutions such that the images may be different in resolution. In some embodiments, the system accesses specifications of each camera to identify the resolutions. In these embodiments, the system may cause resolutions of the input images to be interpolated such that they correspond (e.g., the system may use the highest resolution, lowest resolution, average resolution, and so on). In some embodiments, the system may implement a pre-processing pipeline which indicates that fractional interpolation is to be performed on images from a subset of the image sensors. The system then applies particular fractional interpolation values to at least a portion of the input images.

At block 306, the system pre-processes the input images. The system may optionally apply additional pre-processing, such as filtering, lighting adjustment, and so on.

At block 308, the system provides the input images to a machine learning model or deep learning pipeline. The images, which include at least some fractionally interpolated images, are then provided to a machine learning model. In some embodiments, the machine learning model may be used to implement autonomous or semi-autonomous driving.

### Vehicle Block Diagram

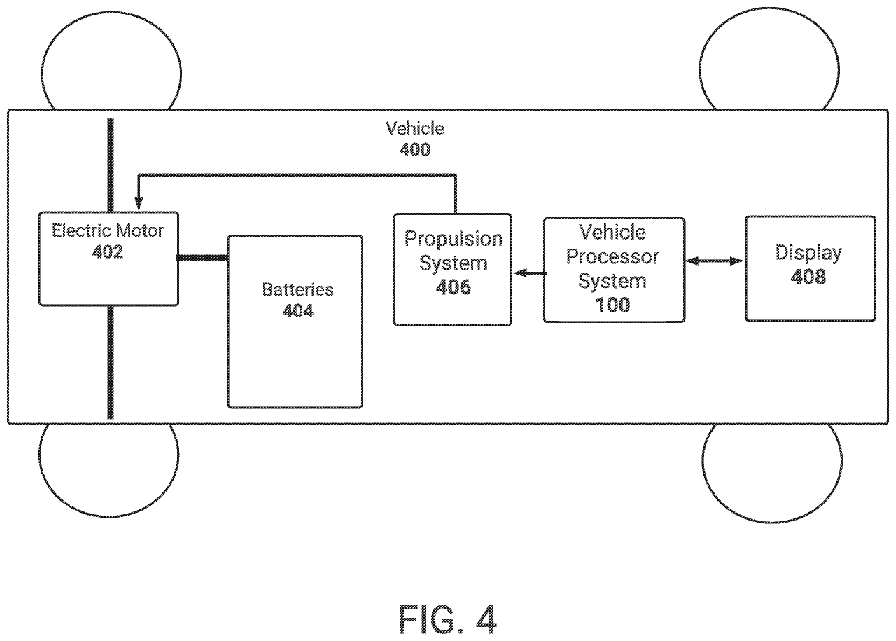

FIG. 4 illustrates a block diagram of a vehicle 400 (e.g., vehicle 102). The vehicle 400 may include one or more electric motors 402 which cause movement of the vehicle 400. The electric motors 402 may include, for example, induction motors, permanent magnet motors, and so on. Batteries 404 (e.g., one or more battery packs each comprising a multitude of batteries) may be used to power the electric motors 402 as is known by those skilled in the art.

The vehicle 400 further includes a propulsion system 406 usable to set a gear (e.g., a propulsion direction) for the vehicle. With respect to an electric vehicle, the propulsion system 406 may adjust operation of the electric motor 402 to change propulsion direction.

Additionally, the vehicle includes the vehicle processor system 100 which is configured to fractionally interpolate data, such as images received from image sensors of the vehicle 400 (e.g., cameras 104A-104N). The vehicle processor system 100 may additionally output information to, and receive information (e.g., user input) from, a display 408 included in the vehicle 400.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A computer-implemented method, the method comprising:
obtaining images from a plurality of image sensors positioned about a vehicle;
determining, for a first image, an interpolation sequence to interpolate the first image according to a fractional interpolation value, wherein the interpolation sequence comprises one or more combinations of respective integer interpolations and integer downsamplings; and
interpolating the first image according to the interpolation sequence.

2. The method of claim 1, wherein the interpolation sequence comprises a first combination including a first interpolation followed by a first downsampling, and further comprises a second combination which receives output from the first combination, wherein the second combination comprises a second interpolation followed by a second downsampling.

3. The method of claim 1, wherein interpolation is performed via a convolutional engine or convolutional processor.

4. The method of claim 3, wherein the convolutional engine or convolutional processor comprises a matrix of computation elements, and wherein the matrix of computational elements is non-systolic.

5. The method of claim 1, wherein interpolation of the first image comprises interpolating the first image and downsampling the first image using convolutional processing.

6. The method of claim 1, wherein values of the integer interpolations multiply to equal a numerator of the fractional interpolation value.

7. The method of claim 1, wherein values of the integer downsamplings multiply to equal a denominator of the fractional interpolation value.

8. A vehicle processor system configured for inclusion in a vehicle, wherein the vehicle processor system is configured to:
obtain images from a plurality of image sensors positioned about a vehicle;
determine, for a first image, an interpolation sequence to int image according to a fractional interpolation value, wherein the interpolation sequence comprises one or more combinations of respective integer interpolations and integer downsamplings; and
interpolate, using a convolutional engine of the vehicle processor system, the first image according to the interpolation sequence.

9. The system of claim 8, wherein the interpolation sequence comprises a first combination including a first interpolation followed by a first downsampling, and further comprises a second combination which receives output from the first combination, wherein the second combination comprises a second interpolation followed by a second downsampling.

10. The system of claim 8, wherein interpolation is performed via a convolutional engine or convolutional processor.

11. The system of claim 10, wherein the convolutional engine or convolutional processor comprises a matrix of computation elements, and wherein the matrix of computational elements is non-systolic.

12. The system of claim 8, wherein interpolation of the first image comprises interpolating the first image and downsampling the first image using convolutional processing.

13. The system of claim 7, wherein values of the integer interpolations multiply to equal a numerator of the fractional interpolation value.

14. The system of claim 8, wherein values of the integer downsamplings multiply to equal a denominator of the fractional interpolation value.

15. Non-transitory computer storage media storing instructions that when executed by a system of one or more processors, cause the one or more processors to:
obtain images from a plurality of image sensors positioned about a vehicle;
determine, for a first image, an interpolation sequence to interpolate the first image according to a fractional interpolation value, wherein the interpolation sequence comprises one or more combinations of respective integer interpolations and integer downsamplings; and
interpolate, using a convolutional engine of the vehicle proc first image according to the interpolation sequence.

16. The computer storage media of claim 15, wherein the interpolation sequence comprises a first combination including a first interpolation followed by a first downsampling, and further comprises a second combination which receives output from the first combination, wherein the second combination comprises a second interpolation followed by a second downsampling.

17. The computer storage media of claim 15, wherein interpolation is performed via a convolutional engine or convolutional processor.

18. The computer storage media of claim 15, wherein interpolation the first image comprises interpolating the first image and downsampling the first image using convolutional processing.

19. The computer storage media of claim 15, wherein values of the integer interpolations multiply to equal a numerator of the fractional interpolation value.

20. The computer storage media of claim 15, wherein values of the integer downsamplings multiply to equal a denominator of the fractional interpolation value.
